(19) United States
(12) Patent Application Publication
(10) Pub. No.: US 2008/0106222 A1
(43) Pub. Date: May 8, 2008

(54) Driven relativistic oscillator to produce controlled deformations in local space-time curvature as a method for achieving particle confinement

(76) Inventor: Joseph Ambrose, Las Cruces, NM (US)

Correspondence Address: Joseph Ambrose, 214 W. Mountain Ave, Las Cruces, NM, 88005, US

(21) Appl. No.: 11/431,865

(22) Filed: Nov. 7, 2006

(51) Int. Cl. H05H 15/00

(52) U.S. Cl. 315/500

(57) ABSTRACT

This claim for patent describes a device which converts electromagnetic energy from an external “pump” laser into energy stored in the gravitational field. Using the pump laser and powerful magnetic constraining fields, charged particles are accelerated to near light speed. Laser energy is converted into increased relativistic mass of the accelerated, driven particles, producing an increase in the magnitude of the local curvature of spate-time. This is the basic method used by the Gravitational Curvature Capacitor (GCC).

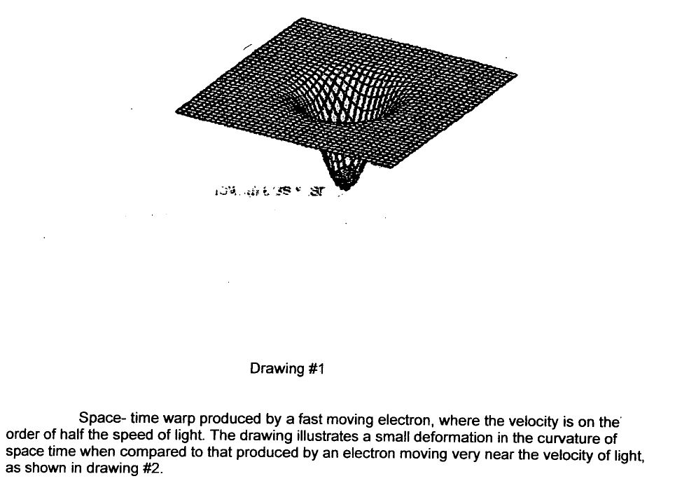

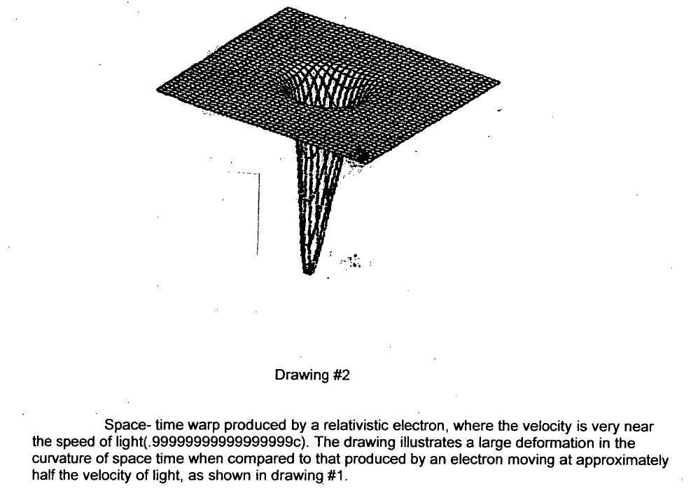

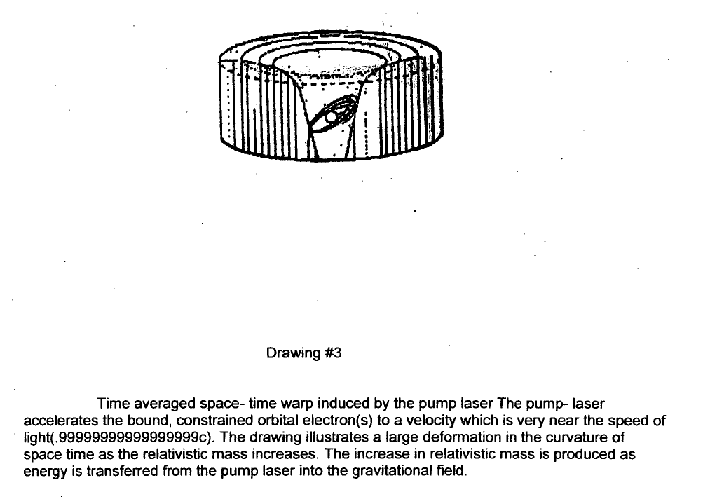

As the electromagnetic pump fields become more intense, requiring a departure from the weak field approximation, a new, dynamical structure emerges in the probability density function describing the orbital electrons.

In a time averaged sense, as the particle relativistic mass increases, with energy supplied by the pump laser, a local warp in the space-time builds. This deformation in space-time produced in this manner is in most ways indistinguishable from that produced by a massive, nearly stationary object.

The GCC is a principal component of the Driven Inertial Mass Oscillator Nutator (DIMON 1) as described in this claim for patent.

This patent application describes a claim for a new and novel device. The operating principles are governed, in part, under the theory of General Relativity, especially as relates to the energy storage processes.

A specific description of the device whose function is to store energy provided by an intense laser pumping source into the local space-time, is provided. The energy storage mechanism relies on relativistic mass effects, produced by near light speed particles, accelerated by the laser pump source, but confined to a volume within a few meter diameter vacuum cell.

This device is referred to in this application as the “Gravitational Curvature Capacitor” (GCC), emphasizing the equivalence of inertial and gravitational mass, which is an important conceptual aspect in understanding how this system functions.

Please reference Provisional patent No. 60/678,545 in what follows.

Key Elements Governing Operation of the GCC

The basic function of the device (and ideas) covered under article is the controlled alteration of the local properties of the Space-Time Continuum (STC) by transferring electromagnetic energy from an external pump source into the STC. The energy transfer is accomplished by using the external pump source to accelerate an ensemble of charged particles to near light speed, while confining the particles within a very strong static electric and magnetic field.

As the relativistic mass effects build, a local warping of the STC occurs in a manner, which if measured, will be like that produced by a massive particle.

A measure of the pump induced warp of the STC is the scalar

M_{WARP}=Mᵣₑₗ−Mᵣₑₛₜ

For the GCC to function effectively, the near light speed particles must be constrained in a number of ways.

1. The particles must be constrained spatially such that the time averaged “dwell” is sufficient to produce the desired time averaged curvature change in the STC.

2. The particles must be constrained such that as accelerating, charged particles, they do not simply reradiate energy from the pump source, as a loss mechanism.

$${M}_{rest} ≡ Rest MASS$$

$${M}_{rel} = {M}_{rest} / {( 1 - \frac{{v}^{2}}{{c}^{2}} )}^{1 / 2}$$

### DEVICE FUNCTION

1. An ensemble of charged particles are constrained, in a hard vacuum. The constraining fields are intense static external magnetic fields, slowly time varying electromagnetic fields, (supplied in a magneto optic trap) and the nuclear coloumbic binding force of a hydrogenic like “core atom”. The particles to be accelerated include the orbital electrons of a hydrogenic system, although not exclusively confined to this.

2. The charged particles are accelerated to very near light speed by the external pump source (an intense laser for example). This, while confined to the ˜2 square meter vacuum test cell.

3. An interferometric probe laser is used, transverse to the pump laser axis to monitor the induced optical path difference (OPD). This OPD is produced by the energy transfer from the pump laser into the STC, as indicated by an increase in the relativistic mass of the near light speed particle(s). What is being measured here is very much like gravitational lensing.

4. As the pump intensity is increased, the particles relativistic mass increases, as the particles approach very near the speed of light. The time averaged effect of the spatially constrained ensemble of near light speed particles on the local STC is to increase the magnitude of the local STC curvature. The presence of near light speed particles will distort the local curvature of the STC. For this warp to persist, in a time averaged sense, the particle “revisit rate” must exceed 1/T where T is the STC “Relaxation Time”.

### SUMMARY OF KEY ELEMENTS

1. As a particle is accelerated to very near light speed, a warp of the STC occurs which when measured is instantaneously, like that produced by an equally massive particle consistent with the Equivalence Principle(see drawings 1-3, attached)

2. Changes in the local STC can be caused by virtue of the energy of configuration (rest mass) or by virtue of the motion of a particle of rest mass M. The latter effect will become measurable for speeds very near the speed of light.

3. By driving the particles, with an external pump source, to very near light speed, in a locally confined region of STC, energy can be stored in the (time averaged) “warping” of the STC.

The amount of induced warp is a function of the energy transferred from the pump source into the local STC, as indicated by the relativistic mass of the moving, near light speed particle(s).

Driven Relativistic Oscillator To Produce Controlled Deformations in Local Space-Time Curvature as a Method for Achieving Particle Confinement

It seems very likely now that neutrino mass can be inferred as nonzero. As a result, a new horizon has appeared in efforts to reconcile the Standard Model with a growing body of experimental evidence indicating the existence of neutrino mass.

The Standard Model has withstood repeated experimental tests for over thirty years with truly impressive results. This despite the openly acknowledged incompleteness in explaining what gives rise to fundamental particle mass. No small deficiency.

The Higgs mechanism is conceptually appealing in that one additional particle (a boson) and one additional force type, mediated by “collisions” with this boson give rise to fundamental particle mass. The details of the Higgs mechanism will likely undergo further development based on experimental results produced by the Large Hadron Collider, once it is brought online. However, the conceptual basis of a Higgs type mechanism is already evidenced, including in fleeting bits of “low energy” collision data.

The fundamental basis of a Higgs type mechanism is the postulation of the intriguing prospect that it does not vanish in vacuum. The lowest energy, or extremum state of the field has some uniform value greater than zero. Theoretically, a Higgs like mechanism has it's origin as an extension of symmetry breaking resulting in the creation of massive vector bosons, subject to gauge invariance. One possible reaction path follows 2H(0)+H(−)=H(+) - - - W(+)+W(−)=Z(0)=H(0)

With W(+), W(−) and Z(0) representing the intermediate vector bosons.

Much of these descriptions are subject to refinement, based on experiment. Indeed as of today, the Higgs boson has yet to be unambiguously detected.

The concept of the vacuum state, as described by Higgs, is most appealing. Heuristically, a particle acquires mass though interactions or “encounters” with bosons. In such an interaction of say an electron with the vacuum state, the progress of the electron in impeded. A left handed electron will “scatter” into a right handed electron upon each encounter with the vacuum bosons. And the converse, such that in a time averaged expectation, a value of mass arises. The expectation value for mass is dependant on the strength of the interaction with the vacuum boson which in turn determines the frequency of collisions. In a time averaged sense as an expectation for particle mass emerges, a higher time averaged number density of vacuum bosons in the immediate vicinity of the particles peak probability density occurs. Like a condensate of bosons being pulled along with the fundamental particle from the sea of bosons making up the vacuum state.

In this mechanism, intrinsic mass of a fundamental particle in imbued by virtue of it's relative “motion” through vacuum. From one point of view, mass has it's origin in a form of viscous like damping induced by the vacuum.

Now, the relativistic momentum is given by

$${P}_{\to } = \frac{{m}_{o}}{{( 1 - \frac{{v}^{2}}{{c}^{2}} )}^{1 / 2}} {V}_{\to } = δ {m}_{o} {V}_{\to }$$

$$with {V}_{\to } ≡ Velocity$$

Where the velocity dependant mass is given by

$$m ( v ) = \frac{{m}_{o}}{{( 1 - \frac{{v}^{2}}{{c}^{2}} )}^{1 / 2}} = δ {m}_{o}$$

The relativistic energy is given as

E=(p²c²+(MoC²)²)^{½}

with c=velocity of light

Where m₀ is the rest of the mass.

The equivalence principle can be stated as inertial mass is indistinguishable from gravitational mass. The local effects of a gravitational field are identical in all respects to the effects of uniform acceleration.

The local effects of a gravitational field produced by a massive body can be described in terms of curved (Riemann) manifolds. The Riemann curvature tensor identically satisfies a differential equation (Bianchi Identity) component by component. Examining the Riemann tensor, a decomposition into the (Ricci tensor) and the (Wehl tensor) is possible. It is this formulation of the Einstein field equations that will serve as the conceptual basis to describe the effect on the vacuum state of a massive body. Increasing (gravitational) mass warps local space time by it's mere presence.

This process is modeled by the Ricci curvature. The absence of (gravitational) mass gives rise to a vanishing Ricci tensor. Non gravitational mass-energy, momentum and stresses are represented in terms of a stress-energy tensor. Thus, it is possible to store energy by locally altering or warping the curvature of space-time. It is here proposed this warp effect can be achieved through the acceleration of a fundamental particle by an electromagnetic field (intense laser source). With the particle in a bound state, in the presence of a static magnetic field, the accelerated particle's relativistic oscillations are highly localized. At this point, a parameter can be defined. The Curvature Relaxation Time (CRT, ultimately a tensor) can be used to characterize the persistence of the local space-time warn. induced by the relativistic particle, through the laser field induced relativistic motion.

The force applied by the electromagnetic field can be constrained to influence the particle according to

$${F}_{\to } = \frac{d}{d t} {P}_{\to } = \frac{d}{d t} ( m ( v ) {V}_{\to } )$$

$$with {V}_{\to } ≡ Velocity , m ( v ) ≡ Velocity depen . mass$$

The velocity dependant mass term is a measure of the transfer of laser energy into “storage” into the mass-energy induced warping of the local space-time as evidenced through a time dependant change to the local curvature*. A *Curvature Capacitor'!

The time averaged behavior of this energy transfer process can be modeled as broken symmetry leading to an emergent structure. A laser induced correlation gives rise to structure in the relativistic particle probability density with self scaled stability that persist in time. A system driven far from equilibrium that has self organized.

The onset of this process will be evident in the solution of the driven Dirac equation, given as

$$i \frac{α}{α t} \vert Ψ >= ( c α ( p + \frac{1}{c} A ( {r}_{\to } , t ) + β {c}^{2} + υ ( r ) ) \vert Ψ > \\ α , β ≡ 4 + 4 Dirac Matrices$$

Valid for spin ½ fundamental particle.

Consider the following example (See DIMON 1 below)

A hydrogenic atom ins confined into a magneto-optic trap. The atomic system is subjected to a static magnetic field of suitable magnitude and alignment to suppress ionization. Further time dependant shaping fields are applied to inhibit higher harmonic generation, which can be viewed as a loss term.

Now the primary laser pumping source is applied and modulated. Within a few tens of cycles, the orbital electron(s) is exhibiting relativistic effects with a structured persistent complexity emerging in the electron's spatial probability density. With the appropriate shaping and pump fields applied, wave packet spreading can be inhibited as the electron approaches the speed of light.

At the critical velocity (very, very close to the speed of light, i.e., 999999999 c+) a form of phase transition will have occurred, wherein significant resonant energy transfer is now occurring from the intense pump laser into the space-time by virtue of the relativistic oscillations of the electron(s).

At the critical velocity, the curvature capacitor can be though of an “energizing”. As this (gravitational) potential well deepens with increasing pump power, a critical well depth is reached wherein local confinement can be stable for some confinement time, T.

A potential well of sufficient depth can be established, with an ensemble of such oscillators, to ignite thermonuclear fusion of the confined mass.

The Driven Inertial Mass Oscillator Nutator (DIMON 1)

This device uses energy provided by an intense, high power pump laser to transfer energy from the laser into storage in the local gravitational field. This energy transfer is accomplished by the acceleration to relativistic speeds, of a constrained and bound electron through the particle's interaction with an intense pump laser. Constraining fields present include a static magnetic field with magnetic field vector suitability aligned.

The laser driven warp of the local space-time curvature gives rise to a gravitational potential well, wherein at a critical well depth, external mass may be introduced and will remain confined for some confinement time, T. At sufficiently deep potential well depth, critical mass will accumulate in a small “pocket” of space-time, igniting thermonuclear fusion.

Ensembles of such relativistic oscillators contained in a magneto-optic type trap undergoing such a process as making up this patent application, will achieve energy breakeven wherein more energy is released than is used to operate the DIMON 1.

*It is tempting to identify the specific source of the local deformation of the space-time to the time averaged presence of vacuum bosons in increased numbers in the immediate vicinity of the relativistic particle's peaks in probability density. In the rest frame of the relativistic electron, the rest mass remains finite.

1. A device which converts electromagnetic energy from an external pump laser into energy stored in the local gravitational field. The device is comprised of an external high energy pump laser, vacuum confinement chamber, high field strength, modulatable magnetic field, primary and secondary low energy ion beam injectors.

2. The system of claim 1 further comprising a source of charged particles which are injected into the vacuum cell, at low energy, wherein the charged particles are accelerated to near light speed through interaction with the external, high energy pump laser.

3. The system of claim 1 further comprised of high field strength, modulatable magnetic field used to confine and constrain the relativistic particles first injected into the vacuum cell at low energy, and subsequently accelerated through interaction with the external pump laser to near light speed.

4. The system of claim 1 wherein a low power interferometric probe is injected into the vacuum cell where the relativistic particles are confined. The interferometric probe is used to measure the induced Space-Time warp created by the relativistic particles. The optical path difference detected by the interferometric probe is a real time measure of the pump laser induced warping of the Space-Time continuum.

5. The system of claim 1 is further comprised of a control system wherein the signal from the interferometric probe is used to control and modulate the external pump laser and constraining magnetic field. The pump laser induced warp of the local gravitational field is controlled and made stable in time in this manner. This control process is used to set the amount of pump laser energy stored in the local gravitational field.

6. The system of claim 1 is further comprised of a secondary ion source wherein low energy ionized particles can be introduced into the vacuum cell in the region of the pump laser induced deformation of the local gravitational field.

7. The system of claim 1 is further comprised of a beam shuttering system for emergency shutoff of the external pump laser.
